(19) United States
(12) Patent Application Publication
(10) Pub. No.: US 2019/0342545 A1
(43) Pub. Date: Nov. 7, 2019

(54) INTRA-PREDICTION MODE-BASED IMAGE PROCESSING METHOD AND APPARATUS FOR SAME

(71) Applicant: LG ELECTRONICS INC., Seoul (KR)

(72) Inventors: Sunmi YOO, Seoul (KR); Naeri PARK, Seoul (KR); Jungdong SEO, Seoul (KR)

(21) Appl. No.: 16/345,604

(22) PCT Filed: Oct. 28, 2016
(86) PCT No.: PCT/KR2016/012297

§ 371 Date: Apr. 26, 2019

(51) Int. Cl. H04N 19/105; H04N 19/11; H04N 19/176; H04N 19/59; H04N 19/124; H04N 19/18

(52) U.S. Cl. CPC H04N 19/105; H04N 19/11; H04N 19/18; H04N 19/59; H04N 19/124; H04N 19/176

(57) ABSTRACT

Disclosed is a method for processing an image based on an intra prediction mode and an apparatus for the same. Particularly, the method may include generating a prediction sample of a sub sampled block in a current block based on an intra prediction mode of the current block; deriving a residual sample of the sub sampled block; reconstructing the sub sampled block by adding the prediction sample to the residual sample; and reconstructing the current block by merging the reconstructed the sub sampled blocks.

### CROSS-REFERENCE TO RELATED APPLICATIONS

This application is the National Stage filing under 35 U.S.C. 371 of International Application No. PCT/KR2016/012297, filed on Oct. 28, 2016, the contents of which are all hereby incorporated by reference herein in their entirety.

### TECHNICAL FIELD

The present invention relates to a still image or moving image processing method and, more particularly, to a method of encoding/decoding a still image or moving image based on an intra-prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

An object of the present invention is to propose a method for utilizing a residual signal of a neighboring sub sampled block as a residual prediction signal (or residual signal predictor) of a current sub sampled block after sub-sampling a block.

In addition, an object of the present invention is to propose a method for interpolating a reconstructed pixel value of a neighboring sub sampled block after sub-sampling a block, and utilizing it for a prediction of a current sub sampled block.

Technical objects to be achieved in the present invention are not limited to the above-described technical objects, and other technical objects not described above may be evidently understood by a person having ordinary skill in the art to which the present invention pertains from the following description.

### Technical Solution

According to an aspect of the present invention, a method for processing an image based on an intra prediction mode may include generating a prediction sample of a sub sampled block in a current block based on an intra prediction mode of the current block; deriving a residual sample of the sub sampled block; reconstructing the sub sampled block by adding the prediction sample to the residual sample; and reconstructing the current block by merging the reconstructed the sub sampled blocks.

According to another aspect of the present invention, an apparatus for processing an image based on an intra prediction mode may include a prediction sample generation unit for generating a prediction sample of a sub sampled block in a current block based on an intra prediction mode of the current block; a residual sample derivation unit for deriving a residual sample of the sub sampled block; a sub sampled block reconstruction unit for reconstructing the sub sampled block by adding the prediction sample to the residual sample; and a current block reconstruction unit for reconstructing the current block by merging the reconstructed the sub sampled block.

Preferably, the step of generating the prediction sample of the sub sampled block may include: generating the prediction sample of the current block based on the intra prediction mode, and generating the prediction sample of the sub sampled block by sub-sampling the prediction block.

Preferably, the step of generating the prediction sample of the sub sampled block may include: generating the prediction sample of the sub sampled block in a unit of the sub sampled block based on the intra prediction mode.

Preferably, the step of deriving the residual sample of the sub sampled block may include: setting the residual sample of any one sub sampled blocks among the multiple sub sampled blocks in the current block as a residual sample prediction value of the current sub sampled block, and deriving the residual sample of the current sub sampled block by adding a differential value of the residual sample of the current sub sampled block to the residual sample prediction value.

Preferably, the residual sample of the sub sampled block used for the residual sample prediction value may be dequantized by using a quantization parameter which is lower than that of the residual sample of the remaining sub sampled block in the current block.

Preferably, the residual sample of the current sub sampled block may be derived by combining the residual sample prediction value and the residual sample differential value by applying weight values, respectively.

Preferably, whether to use the residual sample prediction value may be determined in a unit of a sequence, a picture, a coding unit or a prediction unit.

Preferably, the step of generating the prediction sample of the sub sampled block may include: generating a first sample of the current sub sampled block by performing an intra prediction based on the intra prediction mode, generating a second sample of the current sub sampled block by interpolating the constructed sample of any one of the sub sampled block among the multiple sub sampled blocks in the current block, and generating the prediction sample of the current sub sampled block by adding the first sample and the second sample.

Preferably, the prediction sample of the current sub sampled block may be generated by combining the first sample and the second sample by applying weight values, respectively.

Preferably, the reconstructed sample used for the interpolation may be determined according to the intra prediction mode.

Preferably, whether to generate the second sample may be determined in a unit of a sequence, a picture, a coding unit or a prediction unit.

Preferably, a transform coefficient of the residual sample of the sub sampled block is rearranged in a location of a corresponding sample in the current block, and coefficient-scanned.

Preferably, a transform coefficient of the residual sample of the sub sampled block is arranged in a unit of the sub sampled block, and coefficient-scanned.

### Technical Effects

According to an embodiment of the present invention, a residual signal of a neighboring sub sampled block is utilized as a residual prediction signal, and amount of transmitted residual signal data may be reduced efficiently, and through this, compression performance of an image may be improved.

In addition, according to an embodiment of the present invention, a reconstructed signal of a neighboring sub sampled block is utilized as a prediction signal of a current sub sampled block, and accuracy of the prediction signal may be improved, and accordingly, amount of transmitted data may be reduced.

Effects which may be obtained in the present invention are not limited to the aforementioned effects, and various other effects may be evidently understood by those skilled in the art to which the present invention pertains from the following description.

### DESCRIPTION OF DRAWINGS

The accompanying drawings, which are included herein as a part of the description for help understanding the present invention, provide embodiments of the present invention, and describe the technical features of the present invention with the description below.

FIG. 1 is an embodiment to which the present invention is applied, and shows a schematic block diagram of an encoder in which the encoding of a still image or moving image signal is performed.

FIG. 2 is an embodiment to which the present invention is applied, and shows a schematic block diagram of a decoder in which the encoding of a still image or moving image signal is performed.

FIG. 3 is a diagram for illustrating the split structure of a coding unit to which the present invention may be applied.

FIG. 4 is a diagram for illustrating a prediction unit to which the present invention may be applied.

FIG. 5 is an embodiment to which the present invention is applied and is a diagram illustrating an intra-prediction method.

FIG. 6 illustrates prediction directions according to intra-prediction modes.

FIG. 7 is a diagram for describing a method for sub-sampling a block according to an embodiment of the present invention.

FIG. 8 is a diagram illustrating a method of decoding a block encoded in a prediction within a picture method according to an embodiment of the present invention.

FIG. 9 is a diagram illustrating a schematic block diagram of a decoder according to an embodiment of the present invention.

FIG. 10 is a diagram illustrating a method of encoding a block in a prediction within a picture method according to an embodiment of the present invention.

FIG. 11 is a diagram illustrating a schematic block diagram of an encoder according to an embodiment of the present invention.

FIG. 12 is a diagram for describing an intra prediction method using an interpolation method according to an embodiment of the present invention.

FIG. 13 is a diagram illustrating a method for decoding a block coded in a prediction within a picture method according to an embodiment of the present invention.

FIG. 14 is a diagram illustrating a schematic block diagram of a decoder according to an embodiment of the present invention.

FIG. 15 is a diagram illustrating a method for encoding a block coded in a prediction within a picture method according to an embodiment of the present invention.

FIG. 16 is a diagram illustrating a schematic block diagram of an encoder according to an embodiment of the present invention.

FIG. 17 is a diagram illustrating a method of transmitting a residual signal according to an embodiment of the present invention.

FIG. 18 is a diagram illustrating a method of transmitting a residual signal according to an embodiment of the present invention.

FIG. 19 is a diagram illustrating a method for processing an image based on an intra prediction according to an embodiment of the present invention.

FIG. 20 is a diagram more particularly illustrating an image processing apparatus based on an intra prediction mode according to an embodiment of the present invention.

### MODE FOR INVENTION

Hereinafter, preferred embodiments of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the present invention is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in this specification, a pixel or pixel element is collected referred to as a sample. Furthermore, using a sample may mean using a pixel value or a pixel element value.

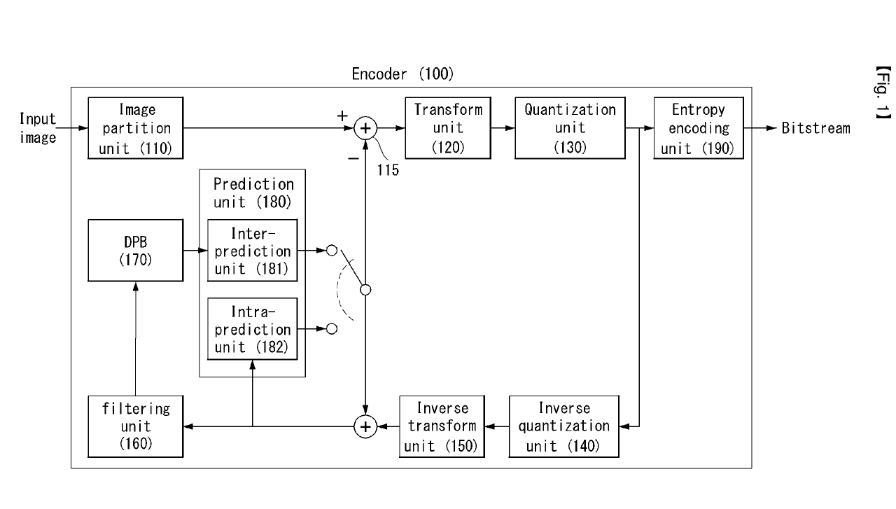

FIG. 1 is an embodiment to which the present invention is applied, and shows a schematic block diagram of an encoder in which the encoding of a still image or moving image signal is performed.

Referring to FIG. 1, an encoder 100 may include a picture split unit 110, a subtraction unit 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter-prediction unit 181 or intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transform to the quantized signal through the dequantization unit 140 and the inverse transform unit 150, the residual signal may be reconstructed. By adding the reconstructed residual signal to the prediction signal that is outputted from the inter-prediction unit 181 or the intra-prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter-prediction unit 181. As such, by using the filtered picture as a reference picture in an inter-picture prediction mode, the encoding rate as well as the image quality may be improved.

The decoded picture buffer 170 may store the filtered picture in order to use it as a reference picture in the inter-prediction unit 181.

The inter-prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter-prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter-prediction unit 181 may perform prediction by generating an interpolation pixel by applying the interpolation filter to the integer pixel, and by using the interpolated block that includes interpolated pixels as a prediction block.

The intra-prediction unit 182 predicts the current block by referring to the samples adjacent the block that is to be encoded currently. The intra-prediction unit 182 may perform the following procedure in order to perform the intra-prediction. First, the intra-prediction unit 182 may prepare a reference sample that is required for generating a prediction signal. Furthermore, the intra-prediction unit 182 may generate a prediction signal by using the reference sample prepared. After, the intra-prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

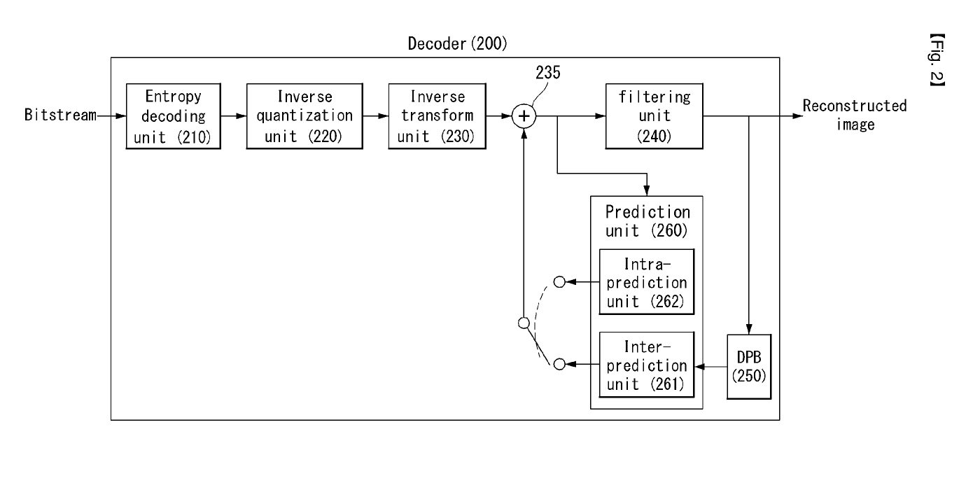

FIG. 2 is an embodiment to which the present invention is applied and shows a schematic block diagram of a decoder in which the encoding of a still image or moving image signal is performed.

Referring to FIG. 2, the decoder 200 may be configured to include an entropy decoding unit 210, a dequantization unit 220, an inverse transform unit 230, an adder 235, a filtering unit 240, a decoded picture buffer unit (DPB) 250, a prediction unit 260. Furthermore, the prediction unit 260 may be configured to include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 of FIG. 1. The received signal is entropy-decoded through the entropy decoding unit 210.

The dequantization unit 220 obtains a transform coefficient from the entropy-decoded signal using quantization step size information.

The inverse transform unit 230 obtains a residual signal (or residual block) by applying an inverse transform scheme to inverse-transform the transform coefficient.

The adder 235 adds the obtained residual signal (or residual block) to a prediction signal (or prediction block), output from the prediction unit 260 (i.e., inter-prediction unit 261 or intra-prediction unit 262), thereby generating a reconstructed signal (or reconstructed block).

The filtering unit 240 applies filtering to the reconstructed signal (or reconstructed block) and outputs the filtered signal to a playback device or transmits it to the decoded picture buffer unit 250. The filtered signal transmitted to the decoded picture buffer unit 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

In general, the block-based image compression method is used in a technique (e.g., HEVC) for compressing a still image or a moving image. A block-based image compression method is a method of processing a video by splitting the video into specific block units, and may decrease the capacity of memory and a computational load.

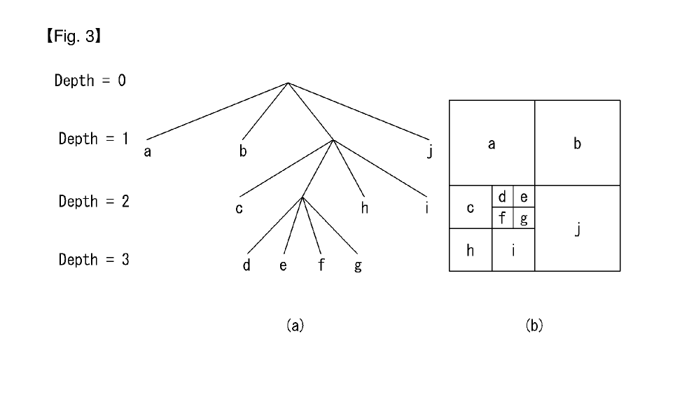

FIG. 3 is a diagram for illustrating the split structure of a coding unit that may be applied to the present invention.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra-prediction or the inter-prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra-prediction and the inter-prediction are not used together for the PUs that belong to a single CU, and the PUs that belong to a single CU are coded by the same prediction method (i.e., intra-prediction or the inter-prediction).

The PU is not split in the Quad-tree structure, but is split once in a single CU in a predetermined form. This will be described by reference to the drawing below.

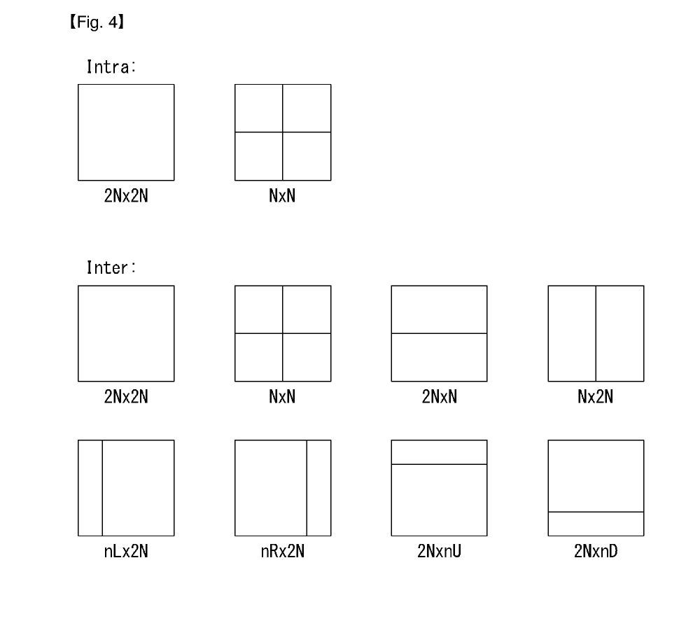

FIG. 4 is a diagram for illustrating a prediction unit that may be applied to the present invention.

A PU is differently split depending on whether the intra-prediction mode is used or the inter-prediction mode is used as the coding mode of the CU to which the PU belongs.

FIG. 4(a) illustrates a PU of the case where the intra-prediction mode is used, and FIG. 4(b) illustrates a PU of the case where the inter-prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra-prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter-prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra-prediction, transformation/quantization, dequantization/inverse transform and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra-prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. ACU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TU(j) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag ‘0’, the corresponding TU is no longer split.

Prediction

In order to reconstruct a current processing unit on which decoding is performed, the decoded part of a current picture including the current processing unit or other pictures may be used.

A picture (slice) using only a current picture for reconstruction, that is, performing only intra-prediction, may be referred to as an intra-picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra-prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter-prediction means a method of predicting the pixel value of the current processing block with reference to reconstructed regions within another reconstructed picture other than a current picture.

Hereinafter, intra-prediction is described in more detail.

Intra Prediction (or Intra-Frame Prediction)

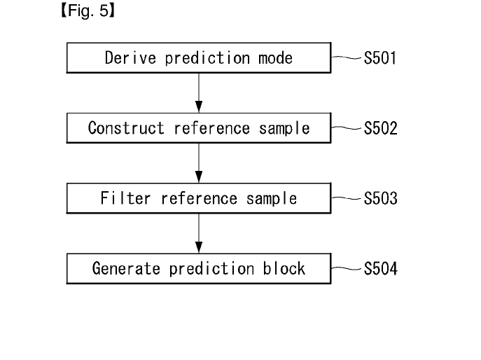

FIG. 5 is an embodiment to which the present invention is applied and is a diagram illustrating an intra-prediction method.

Referring to FIG. 5, the decoder derives the intra-prediction mode of a current processing block (S501).

In intra-prediction, each prediction mode may have a prediction direction for the position of a reference sample used for prediction. An intra-prediction mode having a prediction direction is referred to as an intra-angular prediction mode (Intra_Angular prediction mode). In contrast, an intra-prediction mode not having a prediction direction includes an intra-planar (INTRA_PLANAR) prediction mode, an intra-DC (INTRA_DC) prediction mode.

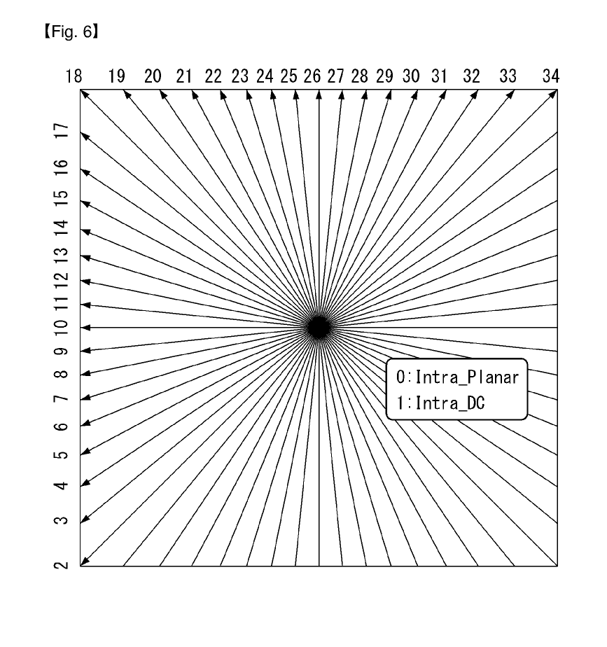

Table 1 illustrates intra-prediction modes and associated names, and FIG. 6 illustrates prediction directions according to intra-prediction modes.

TABLE 1

| INTRA- | |
|---|---|
| PREDICTION | |
| MODE | ASSOCIATED NAMES |
| 0 | INTRA-PLANAR (INTRA_PLANAR) |
| 1 | INTRA-DC (INTRA_DC) |
| 2 . . . , 34 | INTRA-ANGULAR 2 . . . , INTRA-ANGULAR 34 |
| | (INTRA_ANGULAR2 . . . , INTRA_ANGULAR34) |

In intra-prediction, prediction is performed on a current processing block based on a derived prediction mode. A detailed prediction method for a reference sample used for prediction is different based on a prediction mode. If a current block has been encoded in an intra-prediction mode, the decoder derives the prediction mode of the current block in order to perform prediction.

The decoder identifies whether neighboring samples of the current processing block may be used for prediction and constructs reference samples to be used for prediction (S502).

In intra-prediction, neighboring samples of a current processing block mean a sample neighboring the left boundary of the current processing block of an nS×nS size and a total of 2×nS samples neighboring the bottom left of the current processing block, a sample neighboring the top boundary of the current processing block and a total of 2×nS samples neighboring the top right of the current processing block and one sample neighboring the top left of the current processing block.

However, some of neighboring samples of the current processing block has not yet been decoded or may not be available. In this case, the decoder may construct reference samples to be used for prediction by substituting unavailable samples with available samples.

The decoder may perform filtering on the reference samples based on the intra-prediction mode (S503).

Whether or not to perform filtering on the reference samples may be determined based on the size of the current processing block. Furthermore, a filtering method of the reference samples may be determined by a filtering flag transmitted by the encoder.

The decoder generates a prediction block for the current processing block based on the intra-prediction mode and the reference samples (S504). That is, the decoder generates the prediction block for the current processing block (i.e., generate a prediction sample within the current processing block) based on the intra-prediction mode derived in the intra-prediction mode derivation step (S501) and the reference samples obtained through the reference sample configuration step (S502) and the reference sample filtering step (S503).

If the current processing block has been encoded in the INTRA_DC mode, in order to minimize the discontinuity of the boundary between processing blocks, a left boundary sample of a prediction block (i.e., a sample within the prediction block neighboring the left boundary) and a top boundary sample (i.e., a sample within the prediction block neighboring the top boundary) may be filtered in step S504.

Furthermore, in step S504, filtering may be applied to the left boundary sample or the top boundary sample similar to the INTRA_DC mode with respect to a vertical mode and a horizontal mode among intra-angular prediction modes.

More specifically, if the current processing block has been encoded in the vertical mode or the horizontal mode, a value of a prediction sample may be derived based on a reference sample positioned in a prediction direction. In this case, a boundary sample not positioned in the prediction direction among the left boundary sample or top boundary sample of a prediction block may neighbor a reference sample not used for prediction. That is, a distance from the reference sample not used for prediction may be much closer than a distance from a reference sample used for the prediction.

Accordingly, the decoder may adaptively apply filtering to left boundary samples or top boundary samples depending on whether an intra-prediction direction is a vertical direction or a horizontal direction. That is, when the intra-prediction direction is a vertical direction, the decoder may apply filtering to the left boundary samples. When the intra-prediction direction is a horizontal direction, the decoder may apply filtering to the top boundary samples.

A pixel to be referred for prediction may be smoothing (or filtering)-processed based on the size of a current block and a pixel value. This is for reducing the visual artifacts of a prediction block which may be derived due to a difference between the pixel values of reference pixels (or reference samples).

A method used when a block within a frame is predicted using a pixel neighboring a current block may be basically divided into two methods. The method may be divided into an angular prediction method of constructing a prediction block by duplicating a reference pixel positioned in a specific direction and a non-angular prediction method (DC mode, Planar mode) of using a pixel to which reference can be made.

The angular prediction method was designed to represent structures having various directions which may appear in an image (or picture). As described in FIG. 6, the angular prediction method may be performed by designating a specific direction as a prediction mode and duplicating a reference pixel corresponding to a prediction mode angle based o the position of a sample to be predicted.

If a reference pixel cannot be used in an integer pixel unit, a prediction block may be constructed by duplicating an interpolated pixel using a distance ratio between two reference pixels and two pixels derived from the angle of the prediction direction.

ADC mode, that is, one of non-angular prediction modes, is a method of constructing a prediction block based on an average value of reference pixels (or reference samples) neighboring a current block. If pixels within a block are homogeneous, effective prediction can be expected. In contrast, if reference pixels neighboring a current block have various values, discontinuity may occur between a prediction block and a reference sample. When prediction is performed according to the angular prediction method in a similar situation, unwanted visible contouring may occur. The Planar mode was designed to supplement the unwanted visible contouring. In the Planar prediction method, a prediction block is constructed by performing horizontal linear prediction and vertical linear prediction using a reference pixel and then averaging them.

As described above, after the prediction block is constructed, post-processing filtering for reducing the discontinuity of the reference sample and the block boundary may be performed on a block predicted according to the horizontal direction mode, the vertical direction mode and DC mode. Thereafter, an encoded block within a frame may be reconstructed by adding the prediction block and a residual signal that has been input and inverse-transformed as a pixel area.

A decoding process in the case of the intra-frame prediction mode is described. If a currently decoded block has been encoded in an intra-frame prediction mode (or intra-prediction mode), the decoder decodes an encoded residual signal received from the encoder. Furthermore, the decoder decodes a signal symbolized based on the probability in the entropy decoder, and reconstructs the residual signal of a pixel area through dequantization and inverse transform. Furthermore, the decoder generates a prediction block using an intra-frame prediction mode, received from the encoder through the intra-frame prediction unit, and a neighboring reference sample of an already reconstructed current block. Furthermore, the decoder reconstructs a block encoded as intra-frame prediction by adding the prediction signal and the decoded residual signal.

### Embodiment 1

In this embodiment, in order to generate more accurate prediction value (e.g., in order to reduce residual signal data which is transmitted) by utilizing the prediction method within a picture described in FIG. 5 and FIG. 6, it is proposed a method of utilizing a residual signal (or residual sample) of a neighboring sub sampled block for a residual signal prediction of a current sub sampled block, after sub-sampling a block.

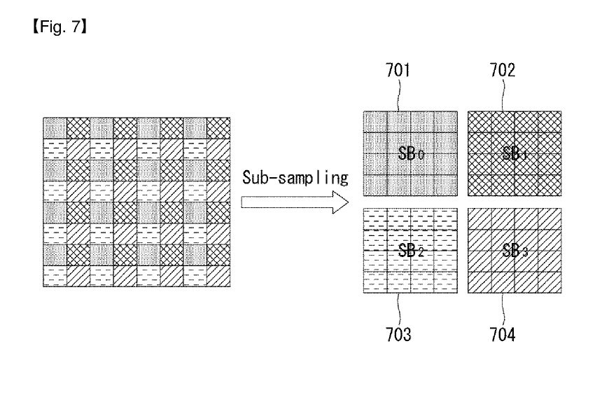

FIG. 7 is a diagram for describing a method for sub-sampling a block according to an embodiment of the present invention.

Referring to FIG. 7, for the convenience of description, it is described a case that sub-sampling is performed with ¼ size for example, but the present invention is not limited thereto. That is, sub-sampling may be performed with a size smaller than ¼ size and applied to the method proposed in the present disclosure.

An encoder/decoder, after generating a prediction block of a current block, may perform sub-sampling of the prediction block, or after sub-sampling the current block, may generate a prediction block of each sub sampled block (or sub sampling block).

First, the encoder/decoder, after generating a prediction block by using a reference sample neighboring the current block, may perform sub-sampling of the prediction block into 4 sub sampled blocks as exemplified in FIG. 7 according to a pixel position. At this time, the sub-sampled prediction blocks with respect to positions of sub sampled block SB0(701), SB1(702), SB2(703) and SB3(704) may be referred to as Pred_SB0, Pred_SB1, Pred_SB2 and Pred_SB3, respectively.

On the other hand, as shown in FIG. 7, the encoder/decoder, after performing sub-sampling the current block, may generate prediction block Pred′_SB0 with respect to a position of sub sampled block SB0 701, and by using the intra prediction mode (Mode_SB0) used for generating Pred′_SB0, may generate prediction blocks (Pred′_SB1, Pred′_SB2 and Pred′_SB3) of the remaining blocks (SB1 702, SB2 703 and SB3 704).

In this case, each of the prediction blocks (Pred′_SB0, Pred′_SB1, Pred′_SB2 and Pred′_SB3) may be generated by using a reference block neighboring the current block based on Mode_SB0. In addition, the prediction blocks (Pred′_SB1, Pred′_SB2 and Pred′_SB3) of the remaining blocks (SB1 702, SB2 703 and SB3 704) may be generated by referring to a prediction sample for SB0 701 position (i.e., Pred′_SB0) or previously generated prediction block as well as the reference block neighboring the current block.

Reconstructed signal Recon_SB0 of the sub sampled block SB0 701 may be generated by combining residual signal Res_SB0 (i.e., a residual signal of a position corresponding to a pixel position of the sub sampled block SB0 701) of a pixel area (or pixel domain) which is transmitted from the encoder and dequantized and inversely transformed with Pred_SB0 (or Pred′_SB0).

It may be assumed that sub sampled blocks sub sampled in a block have high similarity. By utilizing such characteristics, a residual signal of a neighboring sub sampled block is utilized as a residual prediction signal (or residual signal prediction value) of a current sub sampled block, and accordingly, the amount of transmitted signal may be reduced.

Hereinafter, in the description of the present invention, a sub sampled block which is referred by utilizing as a residual prediction signal is referred to as a reference sub sampled block.

As represented in Equation 1, a reconstructed sub sampled block Recon_SBn (n=1, 2, 3) may be generated by using Res_SB0 as a prediction value (i.e., residual prediction signal).

Recon_{sBn}=Pred_{sBn}+(Res_{sBRef}+Res_{sBn}),n=1,2,3,SBRef=SB₀ [Equation 1]

Referring to Equation 1, Res_SB0 corresponds to a residual signal of a reference sub sampled block. Recon_SBn corresponds to a reconstructed sub sampled block of the current sub sampled block (n=1, 2, 3). That is, in the case that Res_SB0 is used for a residual signal prediction, Recon_SBn may be generated by summing prediction blocks Pred_SBn, Res_SB0 and Res_SBn of the current sub sampled block.

Herein, Res_SB0 may be referred to as a residual prediction signal (or residual signal prediction value) and Res_SBn may be referred to as a residual differential signal (or residual signal differential value).

When the residual signal in the case that a residual signal of a sub sampled block (i.e., SBn) is transmitted without any change, not utilizing Res_SB0 as a residual prediction signal is referred to Res′_SBn, the Res′_SBn may correspond to a summation value of Res_SB0 and Res_SBn.

That is, by utilizing Res_SB0 as a residual prediction signal, even in the case that the encoder signals only a differential value (i.e., residual differential signal) of Res′_SBn and Res_SB0, the encoder may sum it with the sub sampled prediction block Pred_SBn and generate reconstructed sub sampled blocks Recon_SBn (n=1, 2, 3).

Accordingly, by utilizing the residual signal of a neighboring sub sampled block as a residual prediction signal of the current sub sampled block, the encoder/decoder may reduce the amount of residual signal data which is transmitted efficiently.

Later, each of the reconstructed sub sampled block may be reconstructed by being rearranged with a predetermined position of an original block (i.e., the reconstructed sub sampled blocks are merged).

In this embodiment, for the convenience of description, it is described a method of referring to a residual signal of a block positioned in sub sampled block SB0 (701 in FIG. 7), but the present invention is not limited thereto. That is, a sub sampling block of other position, not SB0, may also be a reference sub sampled block.

In addition, in a current block, several sub sampled blocks may be designated and used as reference sub sampled blocks.

In the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

Res_{sBn}′=Orig_{sBn}−(Pred_{sBn}+Res_{sBRef}) [Equation 2]

When a residual signal before transform and quantization are performed is referred to Res_SBn′ as represented in Equation 2, the Res_SBn′ may correspond to a value subtracting a prediction sub sampled block and a residual signal of SBRef from an original block of the sub sampled block SBn.

When this embodiment is performed in the encoder, in order to utilize a residual signal of SBn in a sub sampled block to be performed subsequently as a prediction value (i.e., residual prediction signal), after the transform and quantization are performed, inverse transform and dequantization need to be performed again in order to avoid mismatch with the decoder. When the residual signal which is dequantized and inversely transformed after quantization is referred to Res_SBn, owing to the loss due to the quantization, it may be that Res_SBn′≠Res_SBn. On the other hand, in the case of a lossless compression method, a pixel domain residual signal before transform and quantization are performed may be used as a residual prediction signal.

In the method proposed in the present disclosure, in order to decrease dependence between sub sampled blocks, a reference sub sampled block may be limited to a specific sub sampled block. For example, the encoder/decoder may limit a reference sub sampled block to a block located in SB0 (701 in FIG. 7). In this case, since only the residual signal Res_SB0 of SB0 block is referred, when information for Res_SB0 is reconstructed, the remaining sub sampled blocks may be simultaneously encoded/decoded.

In addition, in order to leave possibility of performance improvement, information on whether the encoder refers to other sub sampled block in a currently encoded block or on a certain sub sampled block to be referred may be transmitted, or a reference sub sampled block may be designated by a specific rule in the encoder and the decoder in the same way.

Furthermore, in order to improve quality of SB_ref (i.e., residual prediction signal) used for a prediction value, the encoder/decoder may differently configure quantization parameter (QP) between the reference sub sampled block and other sub sampled block, and the like. That is, in the reference sub sampled block, information lost owing to quantization is decreased by using small QP or QP of a residual signal of a sub sampled block which is not the reference sub sampled block is increased, and accordingly, the amount of transmitted residual signal may be reduced.

In addition, as a method of adjusting amplitude of a residual signal of the reference sub sampled block, a method of performing a weighted sum of residual signals as represented in Equation 3 may be used.

Recon_{sBn}=Pred_{sBn}+(α·Res_{sBRef}+β·Res_{sBn}),α+β=1 [Equation 3]

Referring to Equation 3, a weight value α is applied to a residual signal (i.e., residual prediction signal) of the reference sub sampled block, and a weighted value β is applied to residual signal (i.e., residual differential signal) of a current sub sampled block, and combined, and accordingly, the amplitude of the residual signal may be adjusted. At this time, α+β=1 may be satisfied.

In addition, since the sample position of SB_ref and the position of SBn are not exactly the same, interpolation is performed to the residual signal of SB_ref as represented in Equation 4, and then, the current sub sampled block SBn may be reconstructed.

$${Recon}_{SBn} = {Pred}_{SBn} + ( interpolation ( {Res}_{SBRef} ) + {Res}_{SBn} ) , \\ n = 1 , 2 , 3 , SBRef = {SB}_{0} \qquad [ Equation 4 ]$$

Herein, interpolation(Res_SBRef) means a value in which an interpolation filter is applied to the residual signal Res_SBRef of SB_ref. In other words, the encoder/decoder may apply the interpolation filter to a pixel value of the Res_SBRef, and obtain a residual prediction signal corresponding to a position of the current sub sampled block SBn.

Further, the encoder/decoder may use the signal (interpolation(Res_SBRef)) in which an interpolation filter is applied to the residual signal of the reference sub sampled block as a residual reference signal, and reconstruct the current sub sampled block SBn by adding prediction blocks Pred_SBn and Res_SBn (i.e., residual differential signal) of the sub sampled block to the residual prediction signal.

In addition, a unit of applying the method of this embodiment may be changed. That is, as described above, sub sampling may be performed in a unit of block as described above. Furthermore, the contents described above may be performed in the same way after sub sampling is performed in a unit of slice, a unit of picture, and the like.

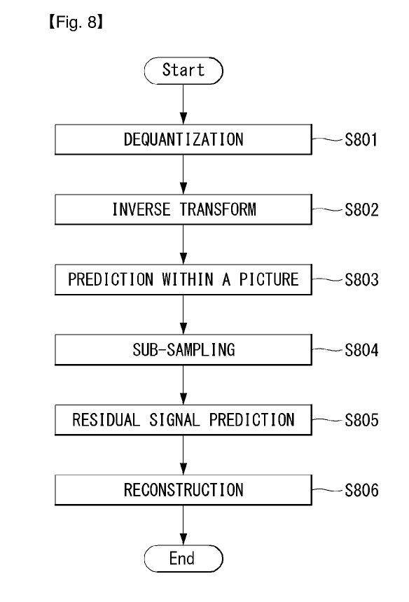

FIG. 8 is a diagram illustrating a method of decoding a block encoded in a prediction within a picture method according to an embodiment of the present invention.

A decoder dequantizes a signal (i.e., bit stream or coefficient) output from an encoder (step, S801).

That is, the decoder obtains a transform coefficient by dequantizing a signal received from the encoder by using quantization step size information.

As described above, in order to improve quality of SB_ref (i.e., residual prediction signal) used for a prediction value, the encoder/decoder may differently configure quantization parameter (QP) between the reference sub sampled block and the remaining sub sampled block, and the like. In this case, the decoder may dequantize the sub sampled block by using different QP values which are derived from the information received from the encoder.

Further, in the case that the signal output from the encoder is entropy-coded, before step S801, the decoder may perform entropy decoding of the received signal.

The decoder inversely transforms the dequantized coefficient (step, S802).

That is, the decoder may inversely transform a transform coefficient by applying the inverse transform technique, and obtain a residual signal (or residual block).

The decoder performs a prediction within a picture for the current block (step, S803).

At this time, the decoder may perform a prediction within a picture in the method described in FIG. 5 and FIG. 6 above. In other words, the decoder may derive a prediction within a picture mode of the current block, and based on the derived prediction within a picture mode, generate a prediction sample (or prediction block) of the current block by using a reference sample neighboring the current block.

The decoder sub-samples a prediction block of the current block (step, S804).

That is, as described in FIG. 7 above, the decoder may sub-sample a prediction block into 4 sub sampled blocks according to pixel positions.

On the other hand, as described above, after sub-sampling the current block as illustrated in FIG. 7 above, the decoder may generate a prediction sample (or prediction block) of the sub sampled block. In addition, the decoder may generate a prediction sample (or prediction block) of the remaining sub sampled blocks by using an intra prediction mode used for generating the prediction sample of the sub sampled block. In this case, step S804 may be performed before performing step S803.

The decoder uses the residual signal of the reference sub sampled block for a residual signal prediction of the current sub sampled block (step, S805).

That is, the decoder may utilize the residual signal of neighboring sub sampled block as a residual prediction signal of the current sub sampled block. As described above, by utilizing the residual prediction signal, the encoder may signal only the residual differential signal of the current sub sampled block. Owing to this, the amount of residual signal data which is transmitted may be efficiently reduced.

The decoder generates a reconstructed signal (or reconstructed block) by adding a prediction signal (or prediction block) to the signal obtained in step S802 (step, S806).

First, the decoder may generate a reconstructed signal (or reconstructed block) by combining a prediction signal (or prediction block) of a reference sub sampled block and a residual signal of a pixel domain which is received from the encoder and dequantized and inversely transformed.

In addition, the decoder may reconstruct the current sub sampled block by summing the currently sub sampled prediction signal (or prediction block), the residual signal of the current sub sampled block and a residual prediction signal (i.e., residual signal of the reference sub sampled block).

Later, the decoder may reconstruct the current block by rearranging (i.e., merging the reconstructed sub sampled blocks) each of the reconstructed sub sampled blocks to a predetermined position of the original block.

As described above, in order to decrease dependency, the reference sub sampled block may be limited to a specific sub sampled block. In addition, several reference sub sampled blocks may be designated and used in the current block as occasion demands. Further, in the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

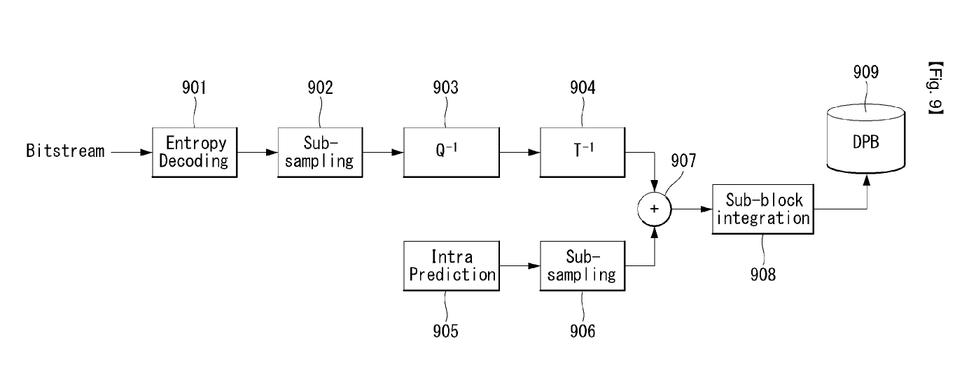

FIG. 9 is a diagram illustrating a schematic block diagram of a decoder according to an embodiment of the present invention.

Referring to FIG. 9, a decoder may include an entropy decoding unit 901, a sub-sampling unit 902, a dequantization unit 903, an inverse transform unit 904, an intra prediction unit 905, a sub-sampling unit 906, an adder 907, a sub-block accumulation unit 908 and a decoded picture buffer 909.

In the description of the present invention, for the convenience of description, an inter prediction unit (261 in FIG. 2), a filtering unit (240 in FIG. 2), and the like are omitted, but the present invention is not limited thereto. Accordingly, the decoder may include the inter prediction unit (261 in FIG. 2) and/or the filtering unit (240 in FIG. 2).

In addition, for the convenience of description, the sub-sampling unit 902 and the sub-sampling unit 906 are shown as separate elements, but the decoder may be implemented by omitting the elements, or implemented with the element being included in the entropy decoding unit 901 and the intra prediction unit 905, respectively.

The decoder may receive a signal (i.e., bit stream) output from the encoder, and the received signal may be entropy-decoded through the entropy decoding unit 901.

The sub-sampling unit 902 may obtain a residual signal (or coefficient) of a sub sampled block from the entropy-decoded signal.

The dequantization unit 903 may obtain a transform coefficient by dequantizing the signal (or residual signal (or coefficient) of the sub-sampled block) received from the encoder based on quantization step size information.

As described above, in order to improve quality of SB_ref (i.e., residual prediction signal) used for a prediction value, the encoder/decoder may differently configure quantization parameter (QP) between the reference sub sampled block and other sub sampled block, and the like. In this case, the dequantization unit 903 may dequantize the sub sampled block by using different QP values which are obtained from the information received from the encoder.

The inverse transform unit 904 may obtain a residual signal (or residual block) by applying an inverse transform scheme to inverse-transform the transform coefficient.

The intra prediction unit 905 predicts the current block by referring to the samples adjacent the block that is to be encoded currently. As described above, the intra prediction unit 905 may perform the following procedures in order to perform the intra prediction. First, the intra prediction unit 905 may prepare a reference sample that is required for generating a prediction signal. In addition, the intra prediction unit 1101 may decode an intra prediction mode. Furthermore, the intra prediction unit 905 may generate a prediction signal (or prediction block) of the current block by using the reference sample neighboring the current block based in an intra prediction mode. In addition, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra prediction.

The sub-sampling unit 906 may perform sub-sampling of the prediction block into 4 sub sampled blocks as exemplified in FIG. 7 according to a pixel position.

On the other hand, as described above, after the current block is sub-sampled first in the sub-sampling unit 906 as shown in FIG. 7, a prediction block of the sub sampled block may be generated in the intra prediction unit 905. And, the intra prediction unit 905 may generate prediction blocks of the remaining blocks by using the intra prediction mode used for generating the sub sampled block.

The adder 907 may generate a reconstructed signal (or reconstructed block) by adding the residual signal dequantized and inversely transformed and the prediction signal (prediction block).

First, the adder 907 may generate a reconstructed signal (or reconstructed block) by combining a prediction signal (or prediction block) of a reference sub sampled block and a residual signal of a pixel domain which is received from the encoder and dequantized and inversely transformed.

In addition, the adder 907 may reconstruct the current sub sampled block by summing the currently sub sampled prediction signal (or prediction block), the residual signal of the current sub sampled block and a residual prediction signal (i.e., residual signal of the reference sub sampled block).

The sub-block accumulation unit 908 may reconstruct the current block by rearranging (i.e., merging the reconstructed sub sampled blocks) each of the reconstructed sub sampled blocks to a predetermined position of the original block.

The adder 907 may output the reconstructed signal (or reconstructed block) to a playback device or transmit it to the decoded picture buffer 909. For the convenience of description, a filtering unit is omitted, but filtering may be performed to remove an image deterioration of the reconstructed picture. At this time, the reconstructed picture in which filtering is performed may be output to a playback device or transmitted to the decoded picture buffer 909.

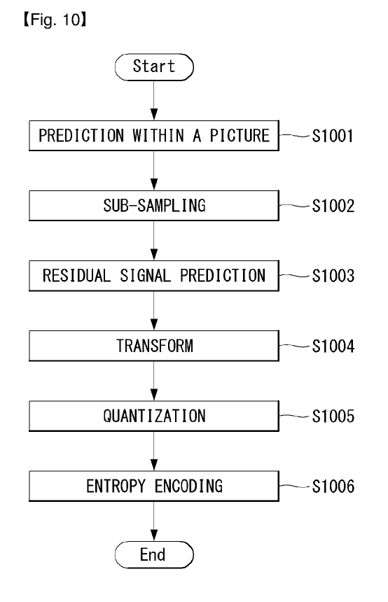

FIG. 10 is a diagram illustrating a method of encoding a block in a prediction within a picture method according to an embodiment of the present invention.

An encoder performs a prediction within a picture for a current block (step, S1001).

At this time, the encoder may perform a prediction within a picture in the method described in FIG. 5 and FIG. 6 above. In other words, the encoder may derive a prediction within a picture mode of the current block, and based on the derived prediction within a picture mode, generate a prediction sample (or prediction block) of the current block by using a reference sample neighboring the current block.

The encoder sub-samples a prediction block of the current block (step, S1002).

That is, as described in FIG. 7 above, the encoder may sub-sample a prediction block into 4 sub sampled blocks according to pixel positions.

On the other hand, as described above, after sub-sampling the current block as illustrated in FIG. 7 above, the encoder may generate a prediction block of the sub sampled block. In addition, the encoder may generate a prediction block of the remaining sub sampled blocks by using an intra prediction mode used for generating the prediction sample of the sub sampled block. In this case, step S1002 may be performed before performing step S1001.

The encoder uses the residual signal of the reference sub sampled block for a residual signal prediction of the current sub sampled block (step, S1003).

That is, the encoder may utilize the residual signal of neighboring sub sampled block as a residual prediction signal of the current sub sampled block. As described above, by utilizing the residual prediction signal, the encoder may signal only the residual differential signal of the current sub sampled block. Owing to this, the amount of residual signal data which is transmitted may be efficiently reduced.

As described above, in order to prevent mismatch between the encoder and the decoder, the residual signal of the reference sub sampled block which is transformed and quantized may be dequantized and inversely transformed again, and utilized for predicting the next sub sampled block.

The encoder generates a transform coefficient by applying a transform technique to the differential signal (or differential block) (step, S1004).

Particularly, the encoder may generate the transform coefficient by applying a transform scheme (e.g., Discrete Cosine Transform (DCT), Discrete Sine Transform (DST), Graph-Based Transform (GBT), Karhunen-Loeve transform (KLT), etc.) to the residual signal of the sub sampled block.

The encoder quantizes the transform coefficient (step, S1005).

As described above, in order to improve quality of SB_ref (i.e., residual prediction signal) used for a prediction value, the encoder may differently configure quantization parameter (QP) between the reference sub sampled block and other sub sampled block, and the like.

The encoder performs entropy coding of the quantized signal, and outputs it in bit stream (step, S1006).

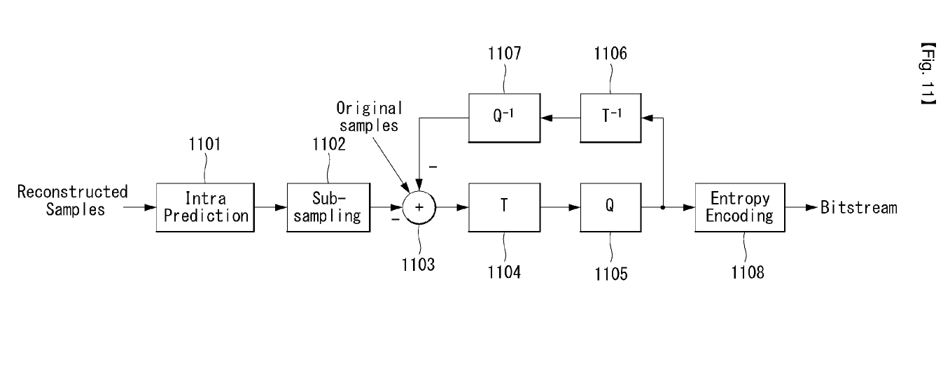

FIG. 11 is a diagram illustrating a schematic block diagram of an encoder according to an embodiment of the present invention.

Referring to FIG. 11 an encoder may include an intra prediction unit 1101, sub-sampling unit 1102, a subtractor 1103, a transform unit 1104, a quantization unit 1105, a dequantization unit 1106, an inverse transform unit 1107 and an entropy encoding unit 1108.

In the description of the present invention, for the convenience of description, an inter prediction unit (181 in FIG. 1), a filtering unit (160 in FIG. 1), a decoded picture buffer (170 in FIG. 1) and the like are omitted, but the present invention is not limited thereto. Accordingly, the encoder may include the inter prediction unit (181 in FIG. 1), the filtering unit (160 in FIG. 1) and/or the decoded picture buffer (170 in FIG. 1).

In addition, for the convenience of description, the sub-sampling unit 1102 is shown as a separate element, but the encoder may be implemented by omitting the element, or implemented with the element being included in the the intra prediction unit 1101.

The intra prediction unit 1101 predicts the current block by referring to the samples adjacent the block that is to be encoded currently. As described above, the intra prediction unit 1101 may perform the following procedures in order to perform the intra prediction. First, the intra prediction unit 1101 may prepare a reference sample that is required for generating a prediction signal. In addition, the intra prediction unit 1101 may decode an intra prediction mode. Furthermore, the intra prediction unit 1101 may generate a prediction signal (or prediction block) of the current block by using the reference sample neighboring the current block based in an intra prediction mode. In addition, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra prediction.

The sub-sampling unit 1102 may perform sub-sampling of the prediction block into 4 sub sampled blocks as exemplified in FIG. 7 according to a pixel position.

On the other hand, as described above, after the current block is sub-sampled first in the sub-sampling unit 1102 as shown in FIG. 7, a prediction block of the sub sampled block may be generated in the intra prediction unit 1101. And, the intra prediction unit 1101 may generate prediction blocks of the remaining blocks by using the intra prediction mode used for generating the sub sampled block.

The subtractor 1103 generates a residual signal (or residual block) by subtracting a prediction signal (or prediction block), output by the intra prediction unit 1101, from the input video signal. The generated residual signal (or residual block) is transmitted to the transform unit 1104.

At this time, in the case that a residual signal of a neighboring sub sampled block is referred as a residual prediction signal, by subtracting a prediction signal of the current sub sampled block output from the intra prediction unit 1101 and a residual signal (i.e., residual prediction signal or residual signal prediction value) of a reference sub sampled block from the input video signal, and a residual signal (i.e., residual differential signal or residual signal differential value) may be generated. The generated residual differential signal may be transmitted to the transform unit 1104.

The transform unit 1104 generates a transform coefficient by applying a transform scheme (e.g., Discrete Cosine Transform (DCT), Discrete Sine Transform (DST), Graph-Based Transform (GBT), Karhunen-Loeve transform (KLT), etc.) to the residual signal (or residual block). At this time, the transform unit 1104 may generate transform coefficients by performing transform using the transform scheme which is determined depending on the prediction mode applied to the residual block and a size of the residual block.

The quantization unit 1105 quantizes the transform coefficient and transmits it to the entropy encoding unit 1108, and the entropy encoding unit 1108 performs entropy-coding of the quantized signal and outputs it in a bit stream.

Meanwhile, the quantized signal output from the quantization unit 1105 may be used for generating a prediction signal (or residual signal). For example, the quantized signal may reconstruct a residual signal by applying dequantization and inverse transform through the dequantization unit 1106 and the inverse transform unit 1107 in a loop. By adding the reconstructed differential signal to the prediction signal output from the intra prediction unit 110, a reconstructed signal may be generated.

As described above, in order to prevent mismatch between the encoder and the decoder, the residual signal of the reference sub sampled block which is transformed and quantized may be dequantized and inversely transformed again, and utilized for predicting the next sub sampled block.

The method proposed in this embodiment may be applied to a luma component and a chroma component in the same manner.

In the case of being applied to the chroma component, a residual signal prediction may be performed separately for the chroma component, or performed after applying a weight value to the residual signal used in the luma component in accordance with a chroma signal.

Alternatively, depending on a format of the chroma signal (4:2:0, 4:2:2, 4:4:4, etc.), the contents described above may be differently applied.

Since it is assumed that sub sampled blocks sub-sampled in a single block (or slice, picture, etc.) have high similarity, a residual signal of a neighboring sub sampled block is utilized as a residual prediction signal of a current sub sampled block, and accordingly, the present invention may reduce the amount of transmitted residual signal data.

### Embodiment 2

In this embodiment, in order to generate more accurate prediction value (e.g., in order to improve an accuracy of prediction) by utilizing the prediction method within a picture, it is proposed a method of utilizing information of previous sub sampled block for a prediction of a current sub sampled block, after sub-sampling a block.

An encoder/decoder, after generating a prediction block of a current block, may perform sub-sampling of the prediction block, or after sub-sampling the current block, may generate a prediction block of each sub sampled block (or sub sampling block).

First, the encoder/decoder, after generating a prediction block by using a reference sample neighboring the current block, may perform sub-sampling of the prediction block into 4 sub sampled blocks as exemplified in FIG. 7 according to a pixel position. At this time, the sub-sampled prediction blocks may be referred to as Pred_SB0, Pred_SB1, Pred_SB2 and Pred_SB3, respectively.

On the other hand, as shown in FIG. 7, the encoder/decoder, after performing sub-sampling the current block, may generate prediction block Pred′_SB0 with respect to a position of sub sampled block SB0 (701 in FIG. 7), and by using the intra prediction mode (Mode_SB0) used for generating Pred′_SB0, may generate prediction blocks (Pred′_SB1, Pred′_SB2 and Pred′_SB3) of the remaining blocks.

In this case, each of the prediction blocks (Pred′_SB0, Pred′_SB1, Pred′_SB2 and Pred′_SB3) may be generated by using a reference block neighboring the current block based on Mode_SB0. In addition, the prediction blocks (Pred′_SB1, Pred′_SB2 and Pred′_SB3) of the remaining blocks may be generated by referring to a prediction sample for SB0 (701 in FIG. 7) position (i.e., Pred′_SB0) or previously generated prediction block as well as the reference block neighboring the current block.

Reconstructed signal Recon_SB0 of the sub sampled block SB0 (701 in FIG. 7) may be generated by combining residual signal Res_SB0 (i.e., a residual signal of a position corresponding to a pixel position of the sub sampled block SB0 (701 in FIG. 7)) of a pixel domain which is transmitted from the encoder and dequantized and inversely transformed with Pred_SB0 (or Pred′_SB0).

It may be assumed that sub sampled blocks sub sampled in a block have high similarity. By utilizing such characteristics, an interpolation may be performed by using reconstructed pixel (or reconstructed sample) information of a neighboring sub sampled block.

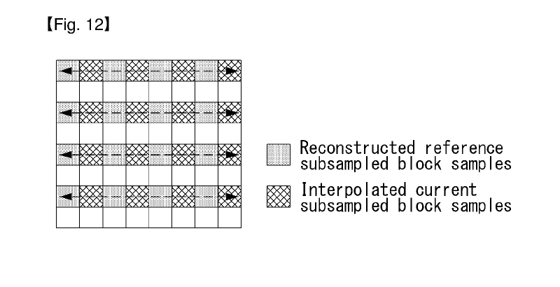

FIG. 12 is a diagram for describing an intra prediction method using an interpolation method according to an embodiment of the present invention.

Referring to FIG. 12, interpolated current sub sampled block samples may be generated by interpolating reconstructed reference sub sampled block samples, and this may be utilized for prediction of a sub sampled block.

In other words, an encoder/decoder may generate samples corresponding to positions of a current sub sampled block by interpolating a reconstructed pixel value of a reference sub sampled block, and this may be used for prediction of a sub sampled block.

At this time, an interpolation may be performed for the reconstructed sub sampled block by using various interpolation methods. For example, in the case that a linear interpolation is performed, the current pixel located between pixels of the reconstructed sub sampled block may be filled with an intermediate value.

The encoder/decoder may generate a new prediction block NewPred_SBn for the current sub sampled block as represented in Equation 5, by using a block (or pixel) in which an interpolation is performed for the current sub sampled block (i.e., interpolated current sub sampled block) based on a pixel value of the reconstructed sub sampled block and a prediction block Pred_SBn.

NewPred_{sBn}=α·Pred_{sBn}+β·Interpolation(Recon_{SB0},SBₙ) [Equation 5]

At this time, interpolation(Recon_SB0,SBn) represents a block in which an interpolation is performed for the current sub sampled block SBn position by utilizing the reconstructed information (or pixel value) of Recon_SB0. In addition, α and β indicate weight values applied to Pred_SBn and the interpolated block (or interpolated sample), respectively, and α+β=1 may be satisfied.

Hereinafter, in describing the present invention, the prediction sample (or prediction block)(i.e., Pred_SBn in the example of Equation 5) of the current sub sampled block generated by performing an intra prediction based on an intra prediction mode of the current block may be referred to as a first sample, and the sample (or block)(i.e., interpolation(Recon_SB0,SBn) in the example of Equation 5) in which an interpolation is performed for a position of the current sub sampled block SBn by interpolating the reconstructed sample of a neighboring sub sampled block may be referred to as a second sample.

That is, the encoder/decoder may generate a prediction sample (or prediction block) NewPred_SBn for the current sub sampled block by summing the first sample and the second sample. In addition, the encoder/decoder may generate a prediction sample of the current sub sampled block by combining the first sample and the second sample to which weight values of α and β are applied, respectively.

Further, the encoder/decoder may select (or apply) an interpolation filter changeably according to a prediction within a picture mode for more accurate interpolation. In other words, the reconstructed sample used for interpolation (to which interpolation is applied) may be determined depending on the prediction within a picture mode of the current block.

For example, in the case that the prediction within a picture is predicted in a vertical direction (predicted by using a top sample among the reference samples neighboring the current block), the method of applying an interpolation filter changeably depending on the prediction within a picture mode may be represented as Equation 6.

NewPred_{sBn}=α·Pred_{sBn}+β·Interpolation(Recon_{SB0},SBₙ,Mode_{Pred}) [Equation 6]

Herein, interpolation(Recon_SB0, SBn, Mode_pred) means a block which is interpolated by utilizing the reconstructed information and the prediction within a picture mode of Recon_SB0 for SBn position of the current sub sampled block.

According to this embodiment, the reconstructed signal of a neighboring sub sampled block is utilized as a prediction signal of the current sub sampled block and accuracy of the prediction signal may be increased efficiently, and accordingly, the amount of residual signal data which is transmitted may be reduced.

The method proposed in this embodiment may be applied to a luma component and a chroma component in the same manner.

In the case of being applied to the chroma component, a residual signal prediction may be performed separately for the chroma component, or performed after applying a weight value to the residual signal used in the luma component in accordance with a chroma signal.

Alternatively, depending on a format of the chroma signal (4:2:0, 4:2:2, 4:4:4, etc.), the contents described above may be differently applied.

In addition, a unit of applying the method of this embodiment may be changed. That is, as described above, the method may be performed in a unit of block, and in addition, sub-sampling is performed in a unit slice, a unit of picture, and the like, and then, the description above may be performed in the same manner.

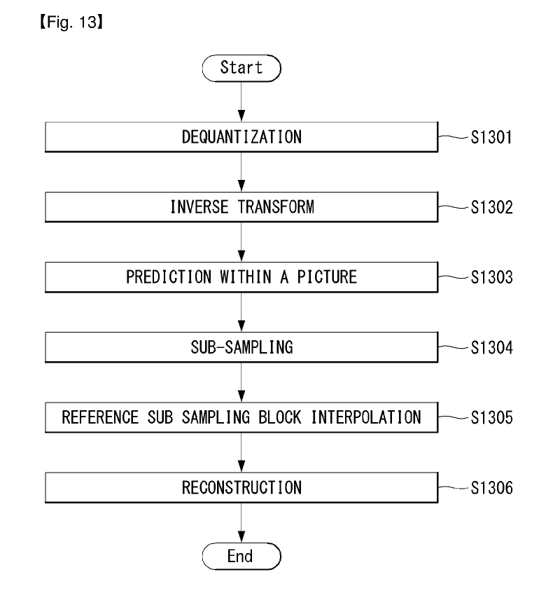

FIG. 13 is a diagram illustrating a method for decoding a block coded in a prediction within a picture method according to an embodiment of the present invention.

A decoder dequantizes a signal (i.e., bit stream or coefficient) output from an encoder (step, S1301).

That is, the decoder obtains a transform coefficient by dequantizing the signal received from the encoder by using quantization step size information.

Further, in the case that the signal output from the encoder is entropy-coded, before step S1301, the decoder may perform entropy-decoding of the received signal.

The decoder inversely transforms the dequantized coefficient (step, S1302).

That is, the decoder may obtain a residual signal (or residual block) by performing inverse transform the transform coefficient by applying inverse transform technique.

The decoder performs a prediction within a picture for a current block (step, S1303).

At this time, the decoder may perform a prediction within a picture in the method described in FIG. 5 and FIG. 6 above. In other words, the decoder may derive a prediction within a picture mode of the current block, and based on the derived prediction within a picture mode, generate a prediction sample (or prediction block) of the current block by using a reference sample neighboring the current block.

The decoder sub-samples a prediction block of the current block (step, S1304).

That is, as described in FIG. 7 above, the decoder may sub-sample a prediction block into 4 sub sampled blocks according to pixel positions.

On the other hand, as described above, after sub-sampling the current block as illustrated in FIG. 7 above, the decoder may generate a prediction sample (or prediction block) of the sub sampled block. In addition, the decoder may generate a prediction sample (or prediction block) of the remaining sub sampled blocks by using an intra prediction mode used for generating the prediction sample of the sub sampled block. In this case, step S1304 may be performed before performing step S1303.

The decoder interpolates a reconstructed sample of a reference sub sampled block (step, S1305).

In other words, the decoder may generate samples corresponding to positions of a current sub sampled block by interpolating a reconstructed pixel value of a reference sub sampled block, and this may be used for prediction of a sub sampled block.

As described above, the decoder may generate a new prediction block for the current sub sampled block by performing a weighted sum of a block (or pixel) in which an interpolation is performed for the current sub sampled block and a prediction block of the current sub sampled block based on a pixel value of the reconstructed reference sub sampled block.

For more accurate interpolation, the decoder may select (or apply) an interpolation filter changeably depending on a prediction within a picture mode. For example, in the case that a prediction within a picture is predicted in a vertical direction (e.g., predicted by using a top sample among the reference samples neighboring the current block), the decoder may also generate an interpolation sample by utilizing a vertical interpolation filter.

The decoder generates a reconstructed signal (or reconstructed block) by adding the prediction signal (or prediction block) to the signal obtained in step S1302 (step, S1306).

That is, the decoder may generate a reconstructed signal (or reconstructed block) by combining a prediction signal (or prediction block) of a sub sampled block and a residual signal of a pixel domain which is received from the encoder and dequantized and inversely transformed.

First, the decoder may generate a reconstructed signal (or reconstructed block) by combining a prediction signal (or prediction block) of a reference sub sampled block and a residual signal of a pixel domain which is received from the encoder and dequantized and inversely transformed.

In addition, the decoder may reconstruct the current sub sampled block by combining the new prediction block in which the interpolated sample (or interpolated block) using the reconstructed pixel value of the reference sub sampled block in step S1305 and the prediction block of the current sob sampled block are weighted-summed and the residual signal of the pixel domain.

Later, the decoder may reconstruct the current block by rearranging (i.e., merging the reconstructed sub sampled blocks) each of the reconstructed sub sampled blocks to a predetermined position of the original block.

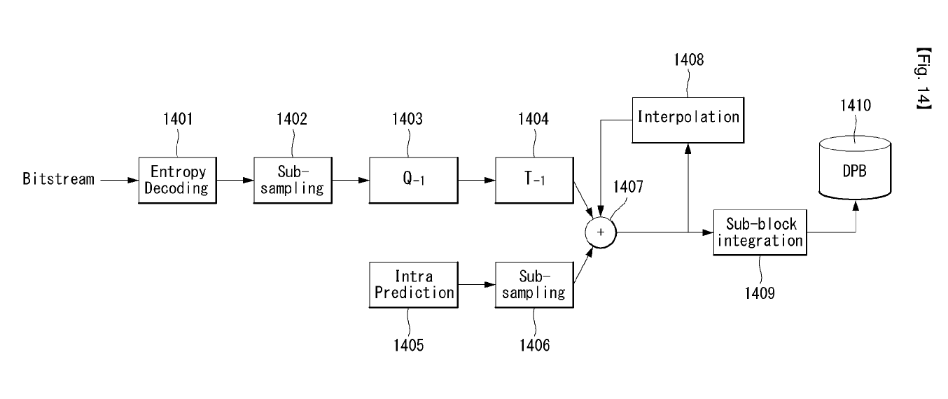

FIG. 14 is a diagram illustrating a schematic block diagram of a decoder according to an embodiment of the present invention.

Referring to FIG. 14, a decoder may include an entropy decoding unit 1401, a sub-sampling unit 1402, a dequantization unit 1403, an inverse transform unit 1404, an intra prediction unit 1405, a sub-sampling unit 1406, an adder 1407, an interpolation unit 1408, a sub-block accumulation unit 1409 and a decoded picture buffer 1410.

In the description of the present invention, for the convenience of description, an inter prediction unit (261 in FIG. 2), a filtering unit (240 in FIG. 2), and the like are omitted, but the present invention is not limited thereto. Accordingly, the decoder may include the inter prediction unit (261 in FIG. 2) and/or the filtering unit (240 in FIG. 2).

In addition, for the convenience of description, the sub-sampling unit 1402 and the sub-sampling unit 1406 are shown as separate elements, but the decoder may be implemented by omitting the elements, or implemented with the element being included in the entropy decoding unit 1401 and the intra prediction unit 1405, respectively.

Hereinafter, it is mainly described different points from the decoder configuration described in FIG. 9 above. The configuration except the configuration described below may perform the same function as the configuration described in FIG. 9.

The adder 1407 may generate a reconstructed signal (or reconstructed block) by adding the residual signal dequantized and inversely transformed and the prediction signal (prediction block).

First, the adder 1407 may generate a reconstructed signal (or reconstructed block) by combining a prediction signal (or prediction block) of a reference sub sampled block and a residual signal of a pixel domain which is received from the encoder and dequantized and inversely transformed. In addition, the reconstructed signal of the reference sub sampled block may be transmitted to the interpolation unit 1408.

The interpolation unit 1408 may generate samples corresponding to positions of the current sub sampled block by interpolating the reconstructed pixel value of the reference sub sampled block, and transmit it to the adder 1407 for utilizing it for prediction the current sub sampled block.

In addition, as described above, for more accurate interpolation, the interpolation unit 1408 may select (or apply) an interpolation filter changeably depending on a prediction within a picture mode.

Furthermore, the adder 1407 may generate a new prediction block for the current sub sampled block by performing a weighted sum of an interpolated sample (or interpolated block) by using a reconstructed pixel value of the reference sub sampled block received from the interpolation unit 1408 and a prediction block of the current sub sampled block. In addition, the adder 1407 may reconstruct the current sub sampled block by combining the generated new prediction block with the residual signal of the pixel domain.

In the present invention, it is described that the adder 1407 generates the new prediction block by performing a weighted sum of the interpolated sample and the prediction block of the current sub sampled block, but the present invention is not limited thereto. That is, generation of the new prediction block may also be performed in the intra prediction unit 1405. In this case, the interpolation unit 1408 may transmit the interpolated sample (or interpolated block) by using a reconstructed pixel value of the reference sub sampled block to the intra prediction unit 1405.

In addition, the intra prediction unit 1405 may perform the interpolation for a position of the current sub sampled block by using the reconstructed pixel value of the sub sampled block. In this case, the interpolation unit 1408 may not be implemented as a separated element, but implemented with a configuration included the intra prediction unit 1405.

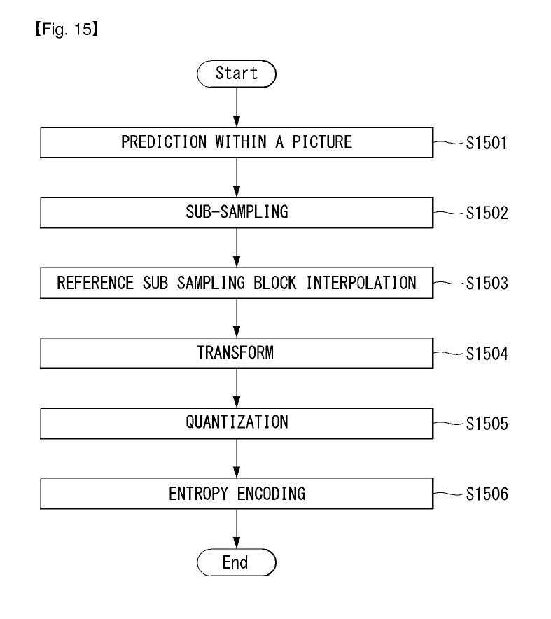

FIG. 15 is a diagram illustrating a method for encoding a block coded in a prediction within a picture method according to an embodiment of the present invention.

The encoder performs a prediction within a picture for a current block (step, S1501).

At this time, the encoder may perform a prediction within a picture in the method described in FIG. 5 and FIG. 6 above. In other words, the encoder may derive a prediction within a picture mode of the current block, and based on the derived prediction within a picture mode, generate a prediction sample (or prediction block) of the current block by using a reference sample neighboring the current block.

The encoder sub-samples a prediction block of the current block (step, S1502).

That is, as described in FIG. 7 above, the encoder may sub-sample a prediction block into 4 sub sampled blocks according to pixel positions.

On the other hand, as described above, after sub-sampling the current block as illustrated in FIG. 7 above, the encoder may generate a prediction block of the sub sampled block. In addition, the encoder may generate a prediction block of the remaining sub sampled blocks by using an intra prediction mode used for generating the prediction sample of the sub sampled block. In this case, step S1502 may be performed before performing step S1501.

The encoder interpolates a reconstructed sample of a reference sub sampled block (step, S1503).

In other words, the encoder may generate samples corresponding to positions of a current sub sampled block by interpolating a reconstructed pixel value of a reference sub sampled block, and this may be used for prediction of a sub sampled block.

As described above, the encoder may generate a new prediction block for the current sub sampled block by performing a weighted sum of a block (or pixel) in which an interpolation is performed for the current sub sampled block and a prediction block of the current sub sampled block based on a pixel value of the reconstructed reference sub sampled block.

In addition, for more accurate interpolation, the encoder may select (or apply) an interpolation filter changeably depending on a prediction within a picture mode.

The encoder generates a transform coefficient by applying the transform technique to a residual signal (or residual block) (step, S1504).

The encoder may transform a signal in a pixel domain to a signal in a frequency domain in order to transmit a residual signal in which the prediction block of the sub sampled block is subtracted from an original block. Particularly, in the case of generating the new prediction block of the current sub sampled block by interpolating the reconstructed pixel value of the reference sub sampled block, the encoder may transform the residual signal generated by subtracting the new prediction block which is generated in step S1503 from the original block.

The encoder may generate a transform coefficient by applying a transform scheme (e.g., Discrete Cosine Transform (DCT), Discrete Sine Transform (DST), Graph-Based Transform (GBT), Karhunen-Loeve transform (KLT), etc.) to the residual signal of the sub sampled block.

The encoder quantizes the transform coefficient (step, S1505).

As described above, in order to improve quality of SB_ref (i.e., residual prediction signal) used for a prediction value, the encoder may differently configure quantization parameter (QP) between the reference sub sampled block and other sub sampled block, and the like.

The encoder performs entropy coding of the quantized signal, and outputs it in bit stream (step, S1506).

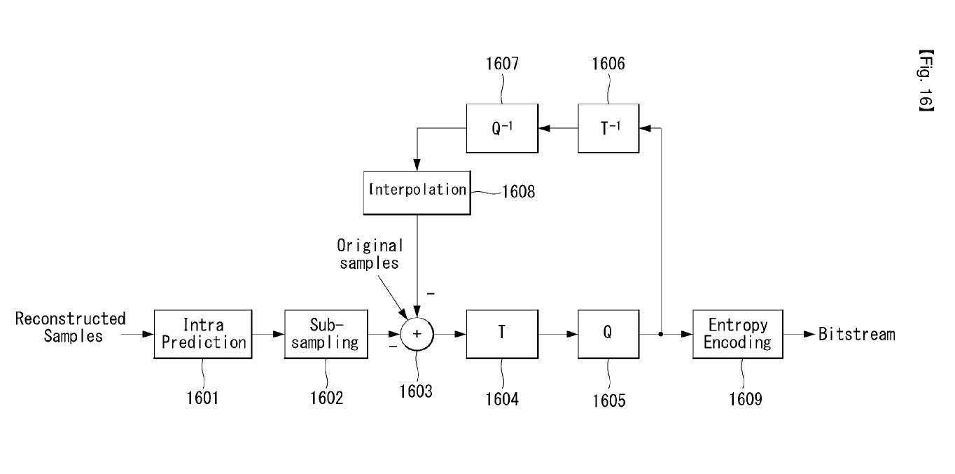

FIG. 16 is a diagram illustrating a schematic block diagram of an encoder according to an embodiment of the present invention.

Referring to FIG. 16, an encoder may include an intra prediction unit 1601, a sub-sampling unit 1602, a subtractor 1603, a transform unit 1604, a quantization unit 1605, a dequantization unit 1606, an inverse transform unit 1607, an interpolation unit 1608 and an entropy encoding unit 1608.

In the description of the present invention, for the convenience of description, an inter prediction unit (181 in FIG. 1), a filtering unit (160 in FIG. 1), a decoded picture buffer (170 in FIG. 1) and the like are omitted, but the present invention is not limited thereto. Accordingly, the encoder may include the inter prediction unit (181 in FIG. 1), the filtering unit (160 in FIG. 1) and/or the decoded picture buffer (170 in FIG. 1).

In addition, for the convenience of description, the sub-sampling unit 1102 is shown as a separate element, but the encoder may be implemented by omitting the element, or implemented with the element being included in the intra prediction unit 1601.

Hereinafter, it is mainly described different points from the encoder configuration described in FIG. 11 above. The configuration except the configuration described below may perform the same function as the configuration described in FIG. 11.

The subtractor 1603 generates a residual signal (or residual block) by subtracting a prediction signal (or prediction block), output by the intra prediction unit 1601, from the input video signal. The generated residual signal (or residual block) is transmitted to the transform unit 1604.

First, the subtractor 1603 may generate a residual signal by subtracting a prediction signal (or prediction block) of a reference sub sampled block from an input image signal. The subtractor 1603 may generate a reconstructed signal by combining the residual signal passing through the transform/quantization and the dequantization/inverse transform with the prediction signal of the reference sub sampled block. In addition, the reconstructed signal of the reference sub sampled block may be transmitted to the interpolation unit 1608 via the transform/quantization and the dequantization/inverse transform.

The interpolation unit 1608 may generate samples corresponding to positions of the current sub sampled block by interpolating the reconstructed pixel value of the reference sub sampled block, and transmit it to the subtractor 1603 for utilizing it for prediction the current sub sampled block.

In addition, as described above, for more accurate interpolation, the interpolation unit 1608 may select (or apply) an interpolation filter changeably depending on a prediction within a picture mode.

Furthermore, the subtractor 1603 may generate a new prediction block for the current sub sampled block by performing a weighted sum of an interpolated sample (or interpolated block) by using a reconstructed pixel value of the reference sub sampled block received from the interpolation unit 1608 and a prediction block of the current sub sampled block. In addition, the subtractor 1603 may reconstruct the current sub sampled block by combining the generated new prediction block with the residual signal of the pixel domain.

In the present invention, it is described that the subtractor 1603 generates the new prediction block by performing a weighted sum of the interpolated sample and the prediction block of the current sub sampled block, but the present invention is not limited thereto. That is, generation of the new prediction block may also be performed in the intra prediction unit 1601. In this case, the interpolation unit 1608 may transmit the interpolated sample (or interpolated block) by using a reconstructed pixel value of the reference sub sampled block to the intra prediction unit 1601.

In addition, the intra prediction unit 1601 may perform the interpolation for a position of the current sub sampled block by using the reconstructed pixel value of the sub sampled block. In this case, the interpolation unit 1608 may not be implemented as a separated element, but implemented with a configuration included the intra prediction unit 1601.

In this embodiment, since it may be assumed that sub sampled blocks sub sampled in a block have high similarity, by utilizing a reconstructed signal of a neighboring sub sampled block as a prediction signal of a current sub sampled block, and accordingly, the accuracy of the prediction signal may be increased efficiently, and the amount of transmitted residual signal data may be reduced.

### Embodiment 3

In this embodiment, in the case that the prediction within a picture method (hereinafter, referred to as sub-sampling method) described in embodiment 1 and embodiment 2 is applied, it is proposed a method of transmitting a residual signal efficiently.

The coefficient scanning and transmission of the residual signal may be performed in the following method.

1) Scan and transmit by arranging in a position of an original block

2) Scan and transmit by arranging in a unit of block which is sub-sampled

The first method corresponds to a method of arranging a transform coefficient of a sub sampled block in a position of an original block.

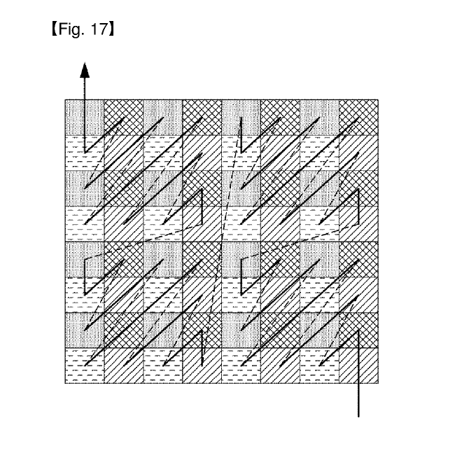

FIG. 17 is a diagram illustrating a method of transmitting a residual signal according to an embodiment of the present invention.

Referring to FIG. 17, an encoder may arrange a sub sampled block in a previous position, before the sub-sampling method applied in prediction is applied, and transmit it.

It is assumed and described that a current block is a block of N×N size.

In the case that the sub-sampling is performed in ¼ size, transform and quantization may be performed for each sub sampled block in N/2×N/2 size. In addition, when a residual signal in which transform and quantization are performed is transmitted, as shown in FIG. 17, the encoder may arrange the residual signal in a position to which each residual signal corresponds, and transmit it in the coefficient scanning method for a block of N×N size. Further, the residual signal may be parsed from a decoder in the same method.

As such, the transform coefficient of the residual signal of a sub sampled block is rearranged, and scanned and transmitted, and accordingly, transform/inverse transform may be performed by using the previously defined transform/inverse transform technique.

At this time, in order to distinguish it from the residual signal (or residual block) of N×N size in which the sub-sampling method is not applied, the encoder may transmit a flag and indicate an explicit indication on whether the sub-sampling method is applied. Alternatively, the sub-sampling method is applied only in a specific condition such as a size of block, a prediction mode, and the like, the decoder may infer (or derive) whether the sub-sampling method is applied in an implicit method.

The second method corresponds to a method of arranging and transmitting in a unit of sub sampled block.

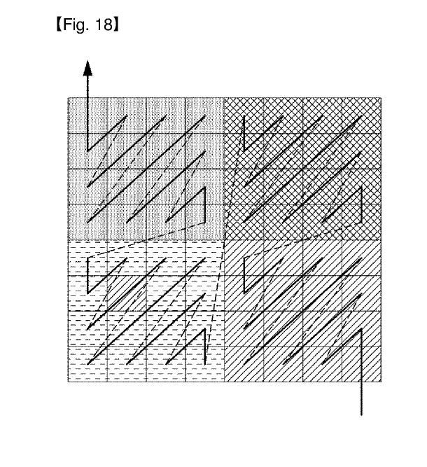

FIG. 18 is a diagram illustrating a method of transmitting a residual signal according to an embodiment of the present invention.

Referring to FIG. 18, the residual signals of a sub sampled block used in prediction and encoding may be grouped in a set, and transmitted by being coefficient scanning, and parsed in a decoder.

In other words, an encoder may arrange the residual signals in a unit of sub sampled block, and signal to the decoder by performing coefficient scanning.

In addition, in the case that the sub-sampling method is applied, a transform unit for the residual signal (or residual block) may not be split.

In this case, the encoder transmits a flag indicating whether the sub-sampling method is applied, or split of the residual signal of N×N size is triggered in the encoder/decoder according to a specific rule, and accordingly, N/2×N/2 inverse transform kernel is applied for properly decoding the residual signal to which the sub-sampling method is applied.

### Embodiment 4

In this embodiment, with respect to the prediction within a picture method (hereinafter, referred to as sub-sampling method) described in embodiment 1 and embodiment 2, it is proposed a method of applying a prediction post processing filter.

In addition, in this embodiment, it is proposed a method of transmitting an indication on whether the sub-sampling method is used (or applied).

The sub-sampling method may apply the prediction within a picture post processing filter described in FIG. 5 and FIG. 6 above. Alternatively, since the prediction within a picture method and the characteristics described in FIG. 5 and FIG. 6 above may be different for the sub-sampling method, the post processing filtering may be omitted only for the block to which the sub-sampling method is applied. Alternatively, the post processing filter may be used only for the block to which the sub-sampling method is applied.

An encoder may transmit a flag indicating whether the sub-sampling method is applied. In addition, the encoder/decoder may infer (or derive) whether the sub-sampling method is applied implicitly according to a specific rule.

In the case that the encoder transmits a flag indicating whether the sub-sampling method is applied, this may be applied in the following level.

1) Video Parameter Set(VPS) Indication

In the case that whether to apply the sub-sampling is indicated in this level, the sub-sampling method may be applied in a prediction within a picture in a current bit stream.

2) Sequence Parameter Set(SPS) Indication

In the case that whether to apply the sub-sampling is indicated in this level, the sub-sampling method may be applied in a prediction within a picture in a corresponding sequence. This may correspond to the case that a bit stream includes several sequences (e.g., multi-view sequence). Even in the case that it is enabled (or turned on) in VPS level, when it is disabled (or turned off) in SPS level, the sub-sampling method may not be applied in the corresponding sequence.

3) Picture Parameter Set(PPS) Indication

In the case that whether to apply the sub-sampling is indicated in this level, the sub-sampling method may be applied in a prediction within a picture in a corresponding picture. Even in the case that it is enabled (or turned on) in VPS and SPS levels, when it is disabled (or turned off) in PPS level, the sub-sampling method may not be applied in the corresponding picture.

4) Slice Header Indication

In the case that whether to apply the sub-sampling is indicated in this level, the sub-sampling method may be applied in a prediction within a picture in a corresponding slice. Even in the case that it is enabled (or turned on) in a higher level, when it is disabled (or turned off) in slice level, the sub-sampling method may not be applied in the corresponding slice.

5) Coding Unit Header Indication

In the case that whether to apply the sub-sampling is indicated in this level, the sub-sampling method may be applied in a prediction within a picture in a corresponding coding unit. Even in the case that it is enabled (or turned on) in a higher level, when it is disabled (or turned off) in coding unit level, the sub-sampling method may not be applied in the corresponding coding unit.

6) Prediction Unit Header Indication

In the case that whether to apply the sub-sampling is indicated in this level, the sub-sampling method may be applied in a prediction within a picture in a corresponding prediction unit. Even in the case that it is enabled (or turned on) in a higher level, when it is disabled (or turned off) in prediction unit level, the sub-sampling method may not be applied in the corresponding prediction unit.

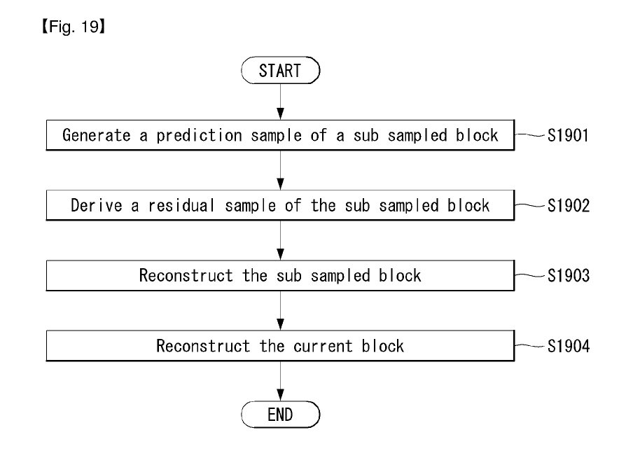

FIG. 19 is a diagram illustrating a method for processing an image based on an intra prediction according to an embodiment of the present invention.

An encoder/decoder generates a prediction sample of a sub sampled block in a current block based on an intra prediction mode of the current block (step, S1901).

Particularly, the encoder/decoder may perform sub-sampling a prediction block after generating the prediction block of the current block, and generate a prediction block of each sub sampled block (or sub sampling block) after sub-sampling the current block.

As described above, the encoder/decoder, after generating the prediction block of the current block by using a reference sample neighboring the current block, may perform sub-sampling of the prediction block into 4 sub sampled blocks as exemplified in FIG. 7 above according to a pixel position of the prediction block.

In addition, as described above, the encoder/decoder, after sub-sampling the current block as exemplified in FIG. 7 above, may generate a prediction sample of the sub sampled block in a unit of sub sampled block based on the intra prediction mode of the current block.

In other words, the encoder/decoder may generate prediction block Pred′_SB0 with respect to a position of sub sampled block SB0 (701 in FIG. 7), and by using the intra prediction mode (Mode_SB0) used for generating Pred′_SB0, may generate prediction blocks (Pred′_SB1, Pred′_SB2 and Pred′_SB3) of the remaining blocks.

In this case, each of the prediction blocks (Pred′_SB0, Pred′_SB1, Pred′_SB2 and Pred′_SB3) may be generated by using a reference block neighboring the current block based on Mode_SB0. In addition, the prediction blocks (Pred′_SB1, Pred′_SB2 and Pred′_SB3) of the remaining blocks may be generated by referring to a prediction sample for SB0 (701 in FIG. 7) position (i.e., Pred′_SB0) or previously generated prediction block as well as the reference block neighboring the current block.

In addition, the encoder/decoder may utilize reconstructed pixel information of the previous sub sampled block for a prediction of the current sub sampled block.

Particularly, as described above, the encoder/decoder may generate a sample corresponding to a position of the current sub sampled block by interpolating a pixel value of a reconstructed reference sub sampled block.

The encoder/decoder may generate a new prediction block by performing a weighted sum of a block (or sample) in which an interpolation is performed for the current sub sampled block and a prediction block (or prediction sample) of the current sub sampled block based on a pixel value of the reconstructed reference sub sampled block.

That is, the encoder/decoder may generate a first sample of the current sub sampled block by performing an intra prediction based on the intra prediction mode, generate a second sample in which an interpolation is performed for a position of the current sub sampled block by interpolating the constructed sample of the reference sub sampled block, and generate the prediction sample of the current sub sampled block by adding (or performing a weighted sum of) the first sample and the second sample.

Further, the encoder/decoder may select (or apply) an interpolation filter changeably according to a prediction within a picture mode for more accurate interpolation. In other words, the reconstructed sample used for interpolation (to which interpolation is applied) may be determined depending on the prediction within a picture mode of the current block.

In addition, as described above, in the current block, several sub sampled blocks may be designated and used as reference sub sampled blocks for residual sample prediction.

In the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

The encoder/decoder derives a residual sample of the sub sampled block (step, S1902).

The encoder may generate the residual sample of the sub sampled block by subtracting a prediction sample of the sub sampled block from an original image (or original block), and transmit the generated residual sample to the decoder. Further, the decoder may derive the residual sample of the sub sampled block from the bit stream which is received from the encoder.

As described above, the encoder/decoder may utilize the residual signal (residual sample) of neighboring sub sampled block as a residual prediction signal of the current sub sampled block.

That is, the encoder/decoder may set the residual sample of the reference sub sampled block in the current block as a residual sample prediction value of the current sub sampled block, and derive the residual sample of the current sub sampled block by adding a residual sample differential value of the current sub sampled block to the residual sample prediction value.

As described above, by utilizing the residual sample of the reference sub sampled block as a residual prediction signal, even in the case that the encoder signals only the residual sample of the reference sub sampled block and the residual differential signal (i.e., residual sample differential value) of the current sub sampled block to the decoder, the decoder may generate a reconstructed sub sampled block by adding it with the prediction sample of the current sub sampled block.

In addition, as described above, several sub sampled blocks may be designated and used in the current block as the reference sub sampled block.

In the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

In addition, respective weight values are applied to a residual signal (i.e., residual prediction signal) of the reference sub sampled block and to residual signal (i.e., residual differential signal) of the current sub sampled block, and combined, and accordingly, the amplitude of the residual signal (or residual sample) may be adjusted.

Furthermore, in order to improve quality of the residual prediction signal used for a prediction value, the encoder/decoder may differently configure quantization parameter (QP) between the reference sub sampled block and other sub sampled block, and the like. That is, in the reference sub sampled block, information lost owing to quantization is decreased by using small QP or QP of a residual signal of a sub sampled block which is not the reference sub sampled block is increased, and accordingly, the amount of transmitted residual signal may be reduced.

In addition, as described above, a transform coefficient of the residual sample of the sub sampled block may be rearranged in a location of a corresponding sample in the current block, and coefficient-scanned and transmitted. In addition, the transform coefficient of the residual sample of the sub sampled block may be rearranged in a unit of sub sampled block in the current block and coefficient-scanned and transmitted in the unit of sub sampled block.

The encoder/decoder reconstructs the sub sampled block by adding the prediction sample to the residual sample (step, S1903).

In step S1901, in the case that the reconstructed pixel value of the reference sub sampled block is interpolated and a new prediction sample of the current sub sampled block is generated, the current sub sampled block may be reconstructed by adding the new prediction sample generated in the residual sample which is derived in step S1902.

In step S1902, in the case that the residual signal (or residual sample) of the reference sub sampled block is used as the residual prediction signal of the current sub sampled block, the encoder/decoder may reconstruct the current sub sampled block by summing the residual differential signal of the current sub sampled block and the prediction sample of the current sub sampled block.

The encoder/decoder reconstructs the current block by merging the reconstructed the sub sampled blocks (step, S1904).

In other words, the encoder/decoder may reconstruct the current block by rearranging each of the reconstructed sub sampled blocks in a predetermined position of the original block.

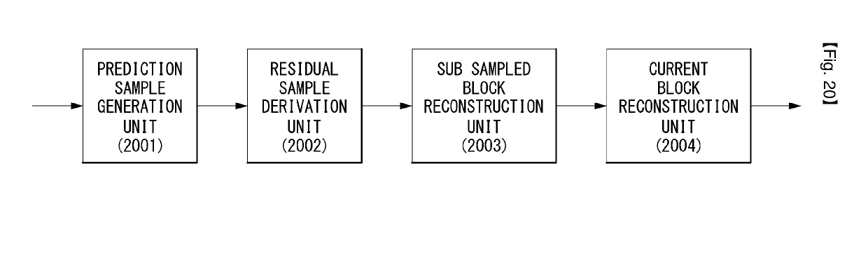

FIG. 20 is a diagram more particularly illustrating an image processing apparatus based on an intra prediction mode according to an embodiment of the present invention.

The image processing apparatus based on an intra prediction mode may include a prediction sample generation unit 2001, a residual sample derivation unit 2002, a sub sampled block reconstruction unit 2003 and a current block reconstruction unit 2004.

The image processing apparatus based on an intra prediction mode implements the function, the process and/or the method proposed in FIG. 8 to FIG. 16 above.

For the convenience of description, in FIG. 20, the image processing apparatus based on an intra prediction mode is shown as a separate element, but the image processing apparatus based on an intra prediction mode (particularly, the prediction sample generation unit 2001) may be implemented as an element which is included in an encoder and/or a decoder.

The prediction sample generation unit 2001 generates a prediction sample of the sub sampled block in a current block based on an intra prediction mode of the current block.

Particularly, the prediction sample generation unit 2001, after generating a prediction block of a current block, may perform sub-sampling of the prediction block, or after sub-sampling the current block, may generate a prediction block of each sub sampled block (or sub sampling block).

As described above, the prediction sample generation unit 2001, after generating a prediction block of the current block by using a reference sample neighboring the current block, may perform sub-sampling of the prediction block into 4 sub sampled blocks as exemplified in FIG. 7 according to a pixel position, and generate a prediction sample of the sub sampled block.

In addition, as described above, the prediction sample generation unit 2001, after sub-sampling the current block as exemplified in FIG. 7, may generate a prediction sample of the sub sampling block in a unit of sub sampling block.

In other words, the prediction sample generation unit 2001 may generate prediction block Pred′_SB0 with respect to a position of sub sampled block SB0 (701 in FIG. 7), and by using the intra prediction mode (Mode_SB0) used for generating Pred′_SB0, may generate prediction blocks (Pred′_SB1, Pred′_SB2 and Pred′_SB3) of the remaining blocks.

In this case, each of the prediction blocks (Pred′_SB0, Pred′_SB1, Pred′_SB2 and Pred′_SB3) may be generated by using a reference block neighboring the current block based on Mode_SB0. In addition, the prediction blocks (Pred′_SB1, Pred′_SB2 and Pred′_SB3) of the remaining blocks may be generated by referring to a prediction sample for SB0 (701 in FIG. 7) position (i.e., Pred′_SB0) or previously generated prediction block as well as the reference block neighboring the current block.

In addition, the prediction sample generation unit 2001 may utilize reconstructed pixel information of the previous sub sampled block for a prediction of the current sub sampled block.

Particularly, as described above, the prediction sample generation unit 2001 may generate a sample corresponding to a position of the current sub sampled block by interpolating a pixel value of a reconstructed reference sub sampled block.

The prediction sample generation unit 2001 may generate a new prediction block by performing a weighted sum of a block (or sample) in which an interpolation is performed for the current sub sampled block and a prediction block (or prediction sample) of the current sub sampled block based on a pixel value of the reconstructed reference sub sampled block.

That is, the prediction sample generation unit 2001 may generate a first sample of the current sub sampled block by performing an intra prediction based on the intra prediction mode, generate a second sample in which an interpolation is performed for a position of the current sub sampled block by interpolating the constructed sample of the reference sub sampled block, and generate the prediction sample of the current sub sampled block by adding (or performing a weighted sum of) the first sample and the second sample.

Further, the prediction sample generation unit 2001 may select (or apply) an interpolation filter changeably according to a prediction within a picture mode for more accurate interpolation.

In the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

The residual sample derivation unit 2002 derives a residual sample of the sub sampled block.

The encoder may generate the residual sample of the sub sampled block by subtracting a prediction sample of the sub sampled block from an original image (or original block), and transmit the generated residual sample to the decoder. Further, the decoder may derive the residual sample of the sub sampled block from the bit stream which is received from the encoder.

As described above, the residual sample derivation unit 2002 may utilize the residual signal (residual sample) of neighboring sub sampled block as a residual prediction signal of the current sub sampled block.

That is, the residual sample derivation unit 2002 may set the residual sample of the reference sub sampled block in the current block as a residual sample prediction value of the current sub sampled block, and derive the residual sample of the current sub sampled block by adding a residual sample differential value of the current sub sampled block to the residual sample prediction value.

In addition, as described above, several sub sampled blocks may be designated and used in the current block as the reference sub sampled block.

In the case that several sub sampled blocks are designated as reference sub sampled blocks, the encoder may transmit information on whether a currently decoded sub sampled block refers to other sub sampled block or a certain block which is referred, or reference sub sampled blocks may be designated by a particular rule in the encoder and the decoder in the same way.

In addition, the residual sample derivation unit 2002 may apply respective weight values to a residual signal (i.e., residual prediction signal) of the reference sub sampled block and to residual signal (i.e., residual differential signal) of the current sub sampled block, and combined, and accordingly, the amplitude of the residual signal (or residual sample) may be adjusted.

Furthermore, in order to improve quality of the residual prediction signal used for a prediction value, the residual sample derivation unit 2002 may differently configure quantization parameter (QP) between the reference sub sampled block and other sub sampled block, and the like. That is, in the reference sub sampled block, information lost owing to quantization is decreased by using small QP or QP of a residual signal of a sub sampled block which is not the reference sub sampled block is increased, and accordingly, the amount of transmitted residual signal may be reduced.

In addition, as described above, a transform coefficient of the residual sample of the sub sampled block may be rearranged in a location of a corresponding sample in the current block, and coefficient-scanned and transmitted. In addition, the transform coefficient of the residual sample of the sub sampled block may be rearranged in a unit of sub sampled block in the current block and coefficient-scanned and transmitted in the unit of sub sampled block.

The sub sampled block reconstruction unit 2003 reconstructs the sub sampled block by adding the prediction sample to the residual sample.

In the case that the reconstructed pixel value of the reference sub sampled block is interpolated and a new prediction sample of the current sub sampled block is generated, the current sub sampled block may be reconstructed by adding the new prediction sample generated in the residual sample.

In the case that the residual signal (or residual sample) of the reference sub sampled block is used as the residual prediction signal of the current sub sampled block, the sub sampled block reconstruction unit 2003 may reconstruct the current sub sampled block by summing the residual differential signal of the current sub sampled block and the prediction sample of the current sub sampled block.

The current block reconstruction unit 2004 reconstructs the current block by merging the reconstructed the sub sampled blocks.

In other words, the current block reconstruction unit 2004 may reconstruct the current block by rearranging each of the reconstructed sub sampled blocks in a predetermined position of the original block.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The aforementioned preferred embodiments of the present invention have been disclosed for illustrative purposes, and those skilled in the art may improve, change, substitute, or add various other embodiments without departing from the technological spirit and scope of the present invention disclosed in the attached claims.

1. A method for processing an image based on an intra prediction mode, comprising:
generating a prediction sample of a sub sampled block in a current block based on an intra prediction mode of the current block;
deriving a residual sample of the sub sampled block;
reconstructing the sub sampled block by adding the prediction sample to the residual sample; and
reconstructing the current block by merging the reconstructed the sub sampled blocks.

2. The method of claim 1, wherein the step of generating the prediction sample of the sub sampled block includes:
generating the prediction sample of the current block based on the intra prediction mode, and
generating the prediction sample of the sub sampled block by sub-sampling the prediction block.

3. The method of claim 1, wherein the step of generating the prediction sample of the sub sampled block includes:
generating the prediction sample of the sub sampled block in a unit of the sub sampled block based on the intra prediction mode.

4. The method of claim 1, wherein the step of deriving the residual sample of the sub sampled block includes:
deriving the residual sample of the current sub sampled block by adding a differential value of the residual sample of the current sub sampled block to the residual sample prediction value, wherein the residual sample of any one sub sampled blocks among the multiple sub sampled blocks in the current block is set as a residual sample prediction value of the current sub sampled block.

5. The method of claim 4, wherein the residual sample of the sub sampled block used for the residual sample prediction value is dequantized by using a quantization parameter which is lower than that of the residual sample of the remaining sub sampled block in the current block.

6. The method of claim 4, wherein the residual sample of the current sub sampled block is derived by combining the residual sample prediction value and the residual sample differential value by applying weight values, respectively.

7. The method of claim 4, wherein whether to use the residual sample prediction value is determined in a unit of a sequence, a picture, a coding unit or a prediction unit.

8. The method of claim 1, wherein the step of generating the prediction sample of the sub sampled block includes:
generating a first sample of the current sub sampled block by performing an intra prediction based on the intra prediction mode,
generating a second sample of the current sub sampled block by interpolating the constructed sample of any one of the sub sampled block among the multiple sub sampled blocks in the current block, and
generating the prediction sample of the current sub sampled block by adding the first sample and the second sample.

9. The method of claim 8, wherein the prediction sample of the current sub sampled block is generated by combining the first sample and the second sample by applying weight values, respectively.

10. The method of claim 8, wherein the reconstructed sample used for the interpolation is determined according to the intra prediction mode.

11. The method of claim 8, wherein whether to generate the second sample is determined in a unit of a sequence, a picture, a coding unit or a prediction unit.

12. The method of claim 1, wherein a transform coefficient of the residual sample of the sub sampled block is rearranged in a location of a corresponding sample in the current block, and coefficient-scanned.

13. The method of claim 1, wherein a transform coefficient of the residual sample of the sub sampled block is arranged in a unit of the sub sampled block, and coefficient-scanned.

14. An apparatus for processing an image based on an intra prediction mode, comprising:
a prediction sample generation unit for generating a prediction sample of a sub sampled block in a current block based on an intra prediction mode of the current block;
a residual sample derivation unit for deriving a residual sample of the sub sampled block;
a sub sampled block reconstruction unit for reconstructing the sub sampled block by adding the prediction sample to the residual sample; and
a current block reconstruction unit for reconstructing the current block by merging the reconstructed the sub sampled blocks.
